(19) United States
(12) Patent Application Publication
(10) Pub. No.: US 2026/0340773 A1
(43) Pub. Date: Oct. 29, 2026

(54) Method and system for underwater optical image enhancement

(71) Applicant: Shandong University of Science and Technology, Qingdao (CN)

(72) Inventors: Xiaodong CUI, Qingdao (CN); Qiuwei ZHU, Qingdao (CN); Zirui YANG, Qingdao (CN); Jiangpeng ZHANG, Qingdao (CN); Xueying WEI, Qingdao (CN); Wenjun LI, Qingdao (CN); Fanlin YANG, Qingdao (CN)

(73) Assignee: Shandong University of Science and Technology, Qingdao (CN)

(21) Appl. No.: 19/439,429

(22) Filed: Jan. 4, 2026

(30) Foreign Application Priority Data
Apr. 28, 2025 (CN) 202510541511.2

(51) Int. Cl. G06T 5/40; G06T 5/73; G06T 5/92; G06T 7/90

(52) U.S. Cl. CPC G06T 5/40; G06T 5/73; G06T 5/92; G06T 7/90; G06T 2207/10024; G06T 2207/20004; G06T 2207/20021; G06T 2207/20072

(57) ABSTRACT

An underwater optical image enhancement method and system. The method calculates dynamic compensation factors by evaluating color attenuation degree of the underwater optical image, corrects a color of the underwater image by utilizing pixel distribution standard deviations between different color channels based on histogram distribution characteristics of image pixels; and based on the corrected image color after underwater image color correction, finally determines a background light estimation value by utilizing a block-indexing strategy through recursive iteration and gradual localization until a set threshold is met; and completes enhancement of the underwater image based on the obtained background light estimation value.

### CROSS-REFERENCE

This application claims the benefit of priority from China Patent Application No. CN 202510541511.2 filed on Apr. 28, 2025, the contents of which are hereby incorporated by reference in their entirety.

### TECHNICAL FILED

The present invention belongs to the technical field of underwater optical image processing, and particularly relates to an underwater optical image enhancement method and system.

### BACKGROUND TECHNOLOGY

Rivers, lakes, and oceans occupy a central position in the ecosystem, providing a living space for countless aquatic organisms, plants, and animals, while also playing a crucial role in global ecological processes such as the carbon cycle and water cycle. In recent years, the rapid development of human society has intensified the demand for underwater environment exploration. Among modern technological means for exploring underwater scenes, acoustic and optical methods are two mainstream approaches. Compared to acoustic data, underwater optical images are favored for their advantages of high resolution and rich color information. With the rapid development of marine resource exploitation and underwater detection technologies, underwater optical imaging systems play an irreplaceable role in fields such as marine ecological monitoring (with a coverage rate of 82%) and underwater engineering inspection (with an average annual application growth rate of 37%). Against the backdrop, how to improve the visibility of underwater optical images has become an urgent frontier issue both domestically and internationally.

However, the absorption and scattering effects of the water medium on light lead to severe quality degradation in the acquired images. The selective absorption of light of different wavelengths by water results in significant color cast in images; the attenuation rate of the red light band exceeds 80% at a water depth of 5 meters, which leads to severe color distortion in imaging. Simultaneously, the backscattering effect caused by suspended particles in water creates a fogging phenomenon, reducing image contrast by more than 60% and blurring detailed textures, which directly affects the visual recognition accuracy and operational reliability of underwater equipment.

Conventional underwater image enhancement methods suffer from severely compromised applicability when facing diverse underwater optical datasets. Traditional physical models typically assume that water optical parameters are fixed values, but spatial variations in parameters such as turbidity and depth in actual environments lead to model mismatch. Particularly in nearshore turbid waters, fluctuations in the attenuation coefficients of the blue and green channels can exceed 20%, causing color banding phenomena in corrected images. Some researchers have proposed a method based on global and local histogram equalization and dual-image multi-scale fusion to improve the quality of real-world and low-light images; however, for underwater images captured by different dedicated underwater cameras in the same scene, the enhanced images fail to achieve background color consistency, and images captured under turbid conditions are not addressed (Bai et al., 2020). Regarding image defogging, the applicability of traditional dark channel prior methods is severely limited in underwater scenarios. The widespread use of artificial light sources results in a lack of truly dark pixels in images; approximately 60% of underwater images cannot accurately estimate background light intensity through traditional methods. Consequently, the underwater dark channel prior has emerged, which discards the red channel that is heavily affected by the underwater environment and uses only data from the blue and green channels as input to complete the defogging task for underwater images (Drews et al., 2013). This method often erroneously estimates the background light when bright objects are present in the image. Considering the current state of technology, there is an urgent need to develop new enhancement methods to break through the following bottlenecks: establishing a dynamic color compensation mechanism that adapts to changes in water quality parameters to solve the color cast problem of conventional methods in complex environments; and designing an estimation model capable of distinguishing true background light from interfering reflections to improve the accuracy of fog effect removal.

Conventional underwater image enhancement methods often focus on the optimization of enhancement algorithms, lacking comprehensive mechanism analysis such as traceability and grading for different underwater degraded images, thereby limiting their applicability in diverse underwater scenarios.

Through the aforementioned analysis, the problems and shortcomings of the existing technology are as follows: existing adaptive methods employ fixed threshold compensation strategies, which are prone to over-compensation when scene lighting conditions change abruptly; for example, when strong artificial lighting intervenes, detail loss in highlight areas may occur. Although deep learning solutions perform well on specific datasets, their color mapping relationships deviate from the real physical process; systematic color cast occurs when water type changes, seriously affecting color consistency across water bodies for equipment. While improved schemes based on the dark channel prior enhance estimation accuracy in some scenes through priority strategies, they still produce significant deviations in regions containing metal reflective bodies or bioluminescence phenomena, resulting in local overexposure or artifacts in defogged images.

### SUMMARY OF THE INVENTION

To overcome the problems in the related art, embodiments of the present invention provide an underwater optical image enhancement method and system, specifically relating to an underwater optical image enhancement method based on dynamic color compensation and refined background light estimation.

The technical solution is as follows: an underwater optical image enhancement method, comprising the following steps:
S1, Performing color correction on an underwater image based on dynamic compensation factors, calculating dynamic compensation factors by evaluating color attenuation degree of the underwater optical image; correcting a color of the underwater image by utilizing pixel distribution standard deviations between different color channels based on histogram distribution characteristics of image pixels;
S2, Based on the corrected image color after underwater image color correction, determining a background light estimation value by utilizing a block-indexing strategy through recursive iteration and gradual localization until a set threshold is met; and
S3, Completing enhancement of the underwater image based on the obtained background light estimation value.

Further, calculating the dynamic compensation factors comprises: according to gray world assumption, for a color-normal image, average values of each of the color channels tend to be the same, and for color attenuation of the underwater image, the color attenuation degree is divided into three levels, comprising mild, moderate, and severe; defining the dynamic compensation factors, performing targeted color compensation on the image according to the different color attenuation degrees, in the targeted color compensation, the Color Cast Value is obtained as follows:

Color Cast Value=max(Ī_{c})−min(Ī_{c})

Wherein, I_{c} represents the image before color compensation, and Ī_{c} represents a mean value of I_{c}.

Further, a color compensation process for a pixel position x in the image comprises:

Normalizing a pixel value of each of the channels to the interval [0, 1]; the color compensation process for the pixel position x in the image is expressed as follows:

$${I}_{c}^{e} = {I}_{c} ( x ) + ( {\overline{I}}_{ref} - {\overline{I}}_{c} ) ( 1 - {I}_{c} ( x ) ) {I}_{ref} ( x )$$

Regarding the histogram distribution characteristics between the color channels, a ratio of the standard deviations is configured to optimize the color compensation process for the pixel position x in the image, a color correction method is expressed as follows:

$$\{ \begin{matrix}{I}_{c}^{e} ( x ) = {I}_{c} ( x ) + ( {\overline{I}}_{ref} - {\overline{I}}_{c} ) ( 1 - {I}_{c} ( x ) ) {I}_{ref} ( x ) \\ {I}_{c}^{f} ( x ) + β \times \frac{σ ( {I}_{ref} )}{σ ( {I}_{c}^{e} )} \times {I}_{c}^{e} ( x )\end{matrix}$$

Wherein,

$${I}_{c}^{e}$$

represents the preliminarily color-compensated image, I_{ref} represents one of the color channels with a largest pixel mean value,

$${I}_{c}^{f} ( x )$$

represents a final enhancement result at the position x in the image, σ( ) denotes solving the standard deviation, β represents the dynamic compensation factor whose value is adjusted according to the different color attenuation degrees; x represents the pixel position of the in the image; Ī_{ref} represents a mean value of I_{ref}, C∈{r, g, b}, wherein r represents the red channel, g represents the green channel, and b represents the blue channel;

In step S2, determining the background light estimation value comprises:
S201, Inputting the color-corrected underwater image;
S202, Obtaining the dark channel image;
S203, Executing the block-indexing strategy, wherein dividing the dark channel image into four equally sized sub-images; performing score statistics on the blocked sub-images;
S204, Iteratively selecting the sub-images with the highest scores as background light candidate regions by continuously iterating on sub-regions with the highest scores until a size of the sub-region meets a preset threshold; if the preset threshold is met, proceeding to step S205; and
S205, Mapping the present region to the color-corrected underwater input image and selecting the maximum pixel value of the input image as the background light estimation value.

In step S203, the score calculation formula is as follows:

Score=mean(I_{sub})−std(I_{sub})

Wherein, Score represents the score of the present region, I_{sub} represents the segmented sub-region, mean( ) denotes solving the mean value, and std( ) denotes solving the standard deviation.

In step S204, if the preset threshold is not met, the process returns to step S203.

In step S205, the maximum pixel value of the input image is the point with the highest brightness.

Another objective of the present invention is to provide an underwater optical image enhancement system, which implements the aforementioned underwater optical image enhancement method, wherein the system comprises:
An underwater image color correction module, configured to perform color correction on the underwater image based on the dynamic compensation factors, to calculate the dynamic compensation factors by evaluating the color attenuation degree of the underwater optical image, and to correct the color of the underwater image by utilizing the pixel distribution standard deviations between the different color channels based on the histogram distribution characteristics of the image pixels;
A background light estimation value determination module, configured to finally determine the background light estimation value based on the corrected image color after underwater image color correction by utilizing the block-indexing strategy through recursive iteration and gradual localization until the set threshold is met; and An underwater image enhancement module, configured to complete the enhancement of the underwater image based on the obtained background light estimation value.

Further, the underwater optical image enhancement system is stored on computer-readable storage medium, the computer-readable storage medium stores a computer program that, when executed by a processor, is operable to implement functions of the aforementioned underwater optical image enhancement system. Further, the underwater optical image enhancement system is applied in underwater optical imaging systems for marine ecological monitoring and underwater engineering inspection.

Combining all the aforementioned technical solutions, the beneficial effects of the present invention are as follows: Aiming at the complexity and heterogeneity of underwater optical image imaging environments, the present invention proposes a foggy image enhancement strategy based on dynamic color compensation and refined background light estimation. Firstly, a dynamic compensation color correction algorithm is proposed. The present algorithm calculates dynamic compensation factors by evaluating the color attenuation degree of underwater optical images and, considering the histogram distribution characteristics of image pixels, corrects the image color by utilizing pixel distribution standard deviations between different color channels, thereby providing more realistic image color for the subsequent image defogging. Secondly, a refined background light estimation strategy is proposed. The present method utilizes a block-indexing strategy to progressively locate through recursive iteration until a set threshold is met, finally determining a more accurate background light estimation value to achieve good image defogging performance. By utilizing the aforementioned two steps, a substantial improvement in the visual quality of underwater images is realized.

The present invention can effectively contribute to the quality enhancement of underwater images. Through analysis of the degradation characteristics of underwater images, it creatively classifies the color attenuation of underwater images into levels and defines the calculation formula for the Color Cast Value. The present invention also proposes a dynamic compensation-based underwater image color correction algorithm, which achieves effective compensation for different degrees of color attenuation in underwater images through creative design of dynamic factors, significantly improving the color correction effect of underwater images. Furthermore, the present invention employs a block-indexing strategy to achieve precise background light indexing, thereby obtaining a more accurate transmittance and, combined with the dark channel prior, achieves good underwater image defogging effects.

### BRIEF DESCRIPTION OF DRAWINGS

The patent or application file contains at least one drawing executed in color. Copies of this patent or patent application publication with color drawing will be provided by the Office upon request and payment of the necessary fee.

The accompanying drawings are incorporated into and constitute a part of this specification, illustrate embodiments consistent with the present disclosure, and serve to explain the principles of the present disclosure together with the description.

FIG. 1 is a flowchart of an underwater optical image enhancement method provided by an embodiment of the present invention;

FIG. 2 is an image pixel distribution diagram for mild color attenuation provided by an embodiment of the present invention

FIG. 3 is an image pixel distribution diagram for moderate color attenuation provided by an embodiment of the present invention;

FIG. 4 is an image pixel distribution diagram for severe color attenuation provided by an embodiment of the present invention;

FIG. 5 is a flowchart for determining a background light estimation value provided by an embodiment of the present invention;

FIG. 6 is a color restoration verification effect diagram of the method proposed by the present invention;

FIG. 7 is an effect diagram of color correction results for images with different degradation degrees according to the present invention;

FIG. 8 is a comparison schematic diagram between the present invention and mainstream methods.

### DETAILED EMBODIMENTS

Hereinafter, to make the above objectives, features, and advantages of the present invention more clearly understood, the specific embodiments of the present invention are described in detail with reference to the accompanying drawings. Many specific details are set forth in the following description to facilitate a full understanding of the present invention. However, the present invention can be implemented in many other ways different from those described herein. Those skilled in the art can make similar improvements without departing from the spirit of the present invention, and therefore the present invention is not limited by the specific embodiments disclosed below.

Aiming at the most common foggy blur degradation type, the present invention proposes an enhancement strategy based on dynamic color compensation and refined background light estimation. Through the design of dynamic compensation factors, effective compensation for different degrees of color attenuation is achieved. On this basis, a block-indexing strategy is configured to obtain a more accurate background light estimation value, which is combined with the dark channel prior to solve the image fogging problem.

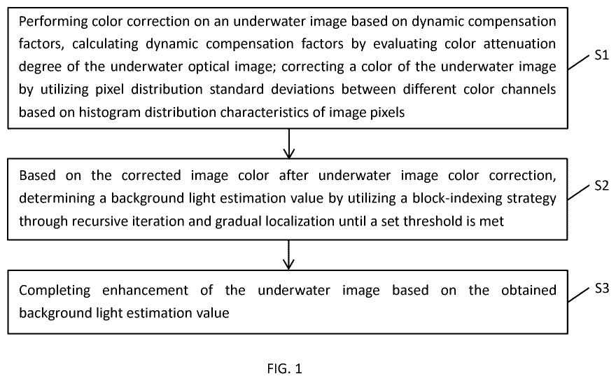

Embodiment 1, as shown in FIG. 1, the underwater optical image enhancement method provided by an embodiment of the present invention comprises:
S1, Performing color correction on an underwater image based on dynamic compensation factors, calculating dynamic compensation factors by evaluating color attenuation degree of the underwater optical image; correcting a color of the underwater image by utilizing pixel distribution standard deviations between different color channels based on histogram distribution characteristics of image pixels;
This provides realistic image color for the subsequent image defogging in background light estimation.

For instance, previous methods performed well in shallow water areas or turbid water environments because, under these conditions, the green channel could retain more complete information compared to the red and blue channels. However, when the environment for acquiring underwater images changes (e.g., acquiring images in clearer and deeper waters), the pixel values of the green channel are generally low, while the relative attenuation of the blue channel is less; at this time, the aforementioned method cannot achieve effective color correction. To solve this problem, the present invention proposes an improved underwater image color correction method. In conventional techniques, a pixel value of each of the channels is normalized to the interval [0, 1]. The color compensation process for the pixel position x in the image is expressed as follows:

$${I}_{c}^{e} = {I}_{c} ( x ) + ( {\overline{I}}_{ref} - {\overline{I}}_{c} ) ( 1 - {I}_{c} ( x ) ) {I}_{ref} ( x ) \qquad ( 1 )$$

Wherein,

$${I}_{c}^{e}$$

represents the preliminarily color-compensated image, I_{ref} represents one of the color channels with a largest pixel mean value,

$${I}_{c}^{f} ( x )$$

represents a final enhancement result at the position x in the image, σ( ) denotes solving the standard deviation, β represents the dynamic compensation factor whose value is adjusted according to the different color attenuation degrees; x represents the pixel position of the in the image; Ī_{ref} represents a mean value of I_{ref}, C∈{r, g, b}, wherein r represents the red channel, g represents the green channel, and b represents the blue channel; I_{c} represents the image before color compensation, and Ī_{c} represents a mean value of I_{c}.

The present invention has found in practice that when the color attenuation of the underwater image is severe, the method of formula (1) cannot achieve ideal enhancement effects. Through analysis, the main reasons in the prior art are as follows:
1) In the absorption and scattering effects of the water medium on light, the attenuation degree of visible light underwater increases significantly with propagation distance. After reaching a certain depth, the information loss in underwater images becomes very severe. At this point, relying solely on the single metric 1−I_{c} (x) in formula (1) is difficult to accurately measure the color attenuation degree of the image.
2) The conventional underwater imaging model (formula (4)) does not consider the distribution characteristics of pixel values and performs color correction only based on differences between color channel means. This method is clearly insufficient for complex color attenuation problems and cannot fully reflect the actual degradation situation of the image.

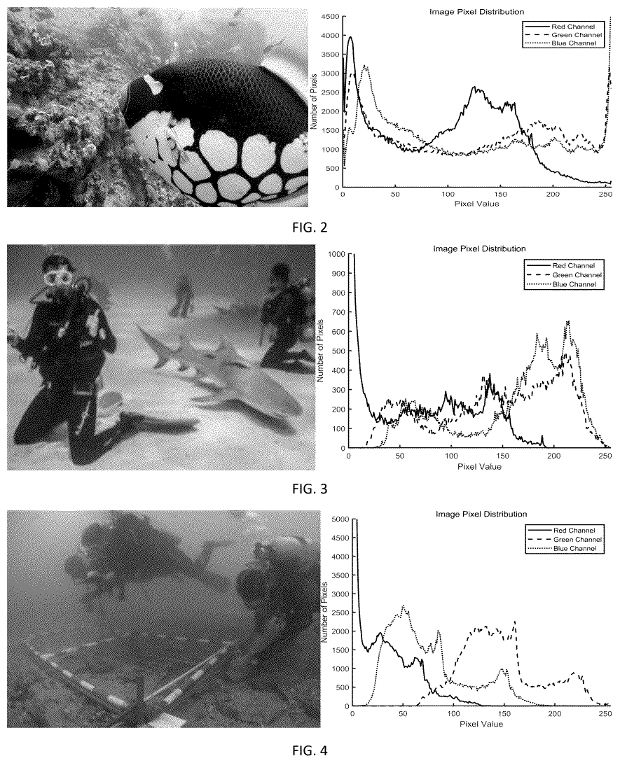

According to the gray world assumption, for a color-normal image, the average values of its color channels should tend to be the same. Based on this theory, for the color attenuation problem of underwater images, the present invention divides the color attenuation degree into three levels: mild, moderate, and severe. For this purpose, a dynamic compensation factor is defined to perform targeted color compensation on the image according to different color attenuation degrees. The definition of the dynamic compensation factor refers to FIG. 2 (an underwater fish with different degrees of color attenuation), FIG. 3 (another underwater fish with different degrees of color attenuation), and FIG. 4 (a diving activity with different degrees of color attenuation); and also with reference to Table 1.

Reference Table 1 for defining the dynamic compensation factors

| Pixel Distribution | Color Cast Value | Degradation Degree | β |
|---|---|---|---|
| FIG. 2 | 28 | Mild 0-50 | 1 |
| FIG. 3 | 107 | Moderate 51-110 | 1.1 |
| FIG. 4 | 120 | Severe 111-255 | 1.2 |

The present invention innovatively proposes that the Color Cast Value is obtained by the following formula:

Color Cast Value=max(Ī_{c})−min(Ī_{c}) (2)

Wherein, I_{c} represents the image before color compensation, and Ī_{c} represents the mean value of I_{c}.

Simultaneously, considering the histogram distribution characteristics between color channels, the ratio of standard deviations is configured to further optimize the process based on formula (1). The present invention innovatively proposes that the final color correction method is expressed as follows:

$$\{ \begin{matrix}{I}_{c}^{e} ( x ) = {I}_{c} ( x ) + ( {\overline{I}}_{ref} - \overline{{I}_{c}} ) ( 1 - {I}_{c} ( x ) ) {I}_{ref} ( x ) \\ {I}_{c}^{f} ( x ) = β \times \frac{σ ( {I}_{ref} )}{σ ( {I}_{c}^{e} )} \times {I}_{c}^{e} ( x )\end{matrix}$$

Wherein,

$${I}_{c}^{e}$$

represents the preliminarily color-compensated image, I_{ref} represents one of the color channels with a largest pixel mean value, I_{c} represents the image before color compensation, and Ī_{c} represents a mean value of I_{c},

$${I}_{c}^{f} ( x )$$

represents a final enhancement result at the position x in the image, σ( ) denotes solving the standard deviation, β represents the dynamic compensation factor whose value is adjusted according to the different color attenuation degrees; x represents the pixel position of the in the image; Ī_{ref} represents a mean value of I_{ref}, C∈{r, g, b}, wherein r represents the red channel, g represents the green channel, and b represents the blue channel;
The color compensation process for the pixel at position x in the image comprises: Although color correction is an indispensable step in underwater image enhancement, it cannot solve the foggy blur problem caused by scattering effects, which is because scattering effects cause loss of edge and detail information. Therefore, the present invention subsequently proposes a method capable of obtaining a more accurate background light estimation value for underwater image defogging processing.
S2: Based on the corrected image color after underwater image color correction, determining a background light estimation value by utilizing a block-indexing strategy through recursive iteration and gradual localization until a set threshold is met;
Finally, a more accurate background light estimation value is determined to achieve good image defogging performance.

For instance, according to the Jaffe-McGlamey underwater optical imaging model, the information obtained by optical image acquisition equipment mainly consists of three parts: (1) Direct Component (DC), wherein the part of light reflected directly from the object surface to the camera; (2) Forward Scattering Component (FSC), wherein the part of light that deviates from the original direction and eventually reaches the camera after scattering; and (3) Backward Scattering Component (BSC), wherein the part of light that interacts with particles in water and scatters before being reflected to the camera. Generally, because the distance between the object and the camera is small, the influence caused by the Forward Scattering Component (FSC) can be neglected. The underwater imaging model can be simplified as follows:

I(x)=J(x)t(x)+B(1−t(x)) (4)

Wherein, J(x)t(x) represents the Direct Component (DC), B(1−t(x)) represents the Backward Scattering Component (BSC), I(x) and J(x) represent the color channel intensity values at image position x for the camera-captured underwater image and the non-degraded underwater image, respectively, B represents the uniform background light, and t(x) represents the medium transmittance, expressed as follows:

t(x)=e^{-βd(x)} (5)

Wherein, d(x) represents the distance between the target scene and the camera, and β represents the attenuation coefficient of the target scene.

The dark channel prior is a prior knowledge derived from statistics of outdoor haze-free images. In most local regions of non-sky areas, some pixels typically exhibit very low intensity in at least one color channel (RGB). The present invention collected and analyzed a large number of outdoor images; by establishing histograms, it is known that approximately 75% of pixel intensities in the dark channel are zero, and 90% are below 25. These statistics provide strong theoretical support for the dark channel prior assumption. The dark channel is defined as follows:

$${J}^{dark} ( x ) = {min}_{y \to Ω ( x )} ( {min}_{c ∈ \{ r , g , b \}} {J}^{c} ( y ) ) \approx 0 \qquad ( 6 )$$

Wherein, J^{dark}(x) represents the pixel at the position x in the dark channel image J^{dark}, y represents a local pixel block, for example of size 3×3, 5×5; c represents one of the R, G, B color channels, J^{c}(y) represents the pixel in region y in one of the R, G, B color channels, {r, g, b} represent the three channels in an RGB image, r represents the red channel, g represents the green channel, b represents the blue channel; and Ω(x) represents the local pixel block centered at the pixel position x.

By rearranging the formula (4), the following formula can be obtained:

$$\frac{I ( x )}{B} = t ( x ) \frac{J ( x )}{B} + 1 - t ( x )$$

In each local window y, the transmittance t(x) is a constant \tilde{t}(x). By applying the minimum operation twice to both sides of the above equation, the following formula can be obtained:

$${min}_{y \to Ω ( x )} ( {min}_{c ∈ \{ r , g , b \}} \frac{{I}^{c} ( y )}{B} ) = \tilde{t} ( x ) {min}_{y \to Ω ( x )} ( {min}_{c ∈ \{ r , g , b \}} \frac{{J}^{c} ( y )}{B} ) + 1 - \tilde{t} ( x )$$

According to the dark channel prior theory and formula (6), the following formula can be obtained:

$$\tilde{t} ( x ) {min}_{y \to Ω ( x )} ( {min}_{c ∈ \{ r , g , b \}} \frac{{J}^{c} ( y )}{B} ) \approx 0$$

$$Namely : {min}_{y \to Ω ( x )} ( {min}_{c ∈ \{ r , g , b \}} \frac{{I}^{c} ( y )}{B} ) = 1 - \tilde{t} ( x )$$

Considering formulas (4) and (6), in order to obtain a more accurate background light, the present invention utilizes the image I(x) captured by the camera and the background light B to estimate the transmittance \tilde{t}(x), with the expression as follows:

$$\tilde{t} ( x ) = 1 - {min}_{y \to Ω ( x )} ( {min}_{c ∈ \{ r , g , b \}} \frac{{I}^{c} ( y )}{B} ) \qquad ( 7 )$$

Considering that a quite small transmittance value t(x) can lead to excessively high pixel values in the restored image, thereby making the overall image shift towards a white field, a threshold to is generally set for constraint, and the final image defogging formula is as follows:

$$J ( x ) = \frac{I ( x ) - B}{max ( t ( x ) , {t}_{0} )} + B \qquad ( 8 )$$

It can be known from the formula (8) that, as long as the present invention can obtain accurate background light B and transmittance t(x), a clear image can be restored. However, applying the dark channel prior directly to the defogging processing of underwater optical images does not yield ideal results.

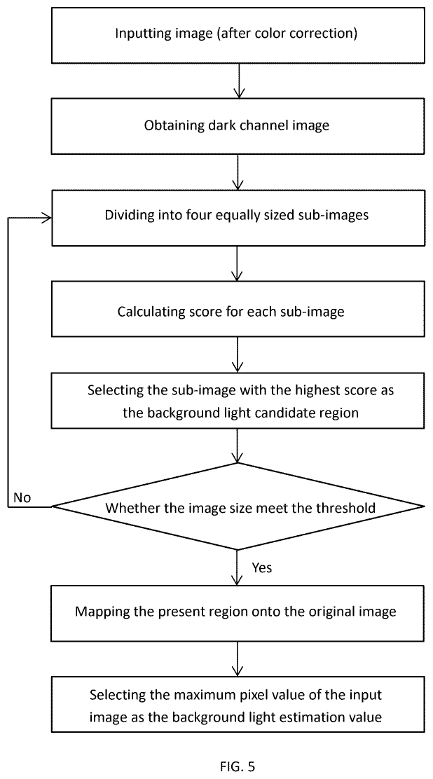

Therefore, the present invention proposes a process for determining the background light estimation value, as shown in FIG. 5. The refined background light estimation of the present invention is performed on the color-corrected underwater image. After color correction, the color cast of the underwater image is partially restored. At this time, the foggy blur phenomenon is closer to the state of outdoor hazy images, allowing the dark channel prior to perform better. Previous methods often erroneously estimated the background light when overly bright non-background light objects were present in the image, thereby affecting the estimated transmittance value. To address this issue, the present invention utilizes the characteristics that background light regions are continuous and have high pixel values, adopting a block-based search method to estimate the region where the background light is located.

Wherein, determining the background light estimation value comprises:
S201, Inputting the color-corrected underwater image;
S202, Obtaining the dark channel image;
S203, Executing the block-indexing strategy, wherein dividing the dark channel image into four equally sized sub-images; performing score statistics on the blocked sub-images;
Performing score statistics on the divided sub-images, the present invention innovatively proposes that the score calculation formula is as follows:

Score=mean(I_{sub})−std(I_{sub})

Wherein, Score represents the score of the present region, I_{sub} represents the segmented sub-region, mean( ) denotes solving the mean value, and std( ) denotes solving the standard deviation.
S204, Iteratively selecting the sub-images with the highest scores as background light candidate regions by continuously iterating on sub-regions with the highest scores until a size of the sub-region meets a preset threshold (the threshold refers to the size/dimension of the segmented sub-image, for example 32×32; iteration stops when it is smaller than this size); if the preset threshold is met, proceeding to step S205; and
S205, Mapping the present region to the color-corrected underwater input image and selecting the maximum pixel value of the input image as the background light estimation value.

S3, Completing enhancement of the underwater image based on the obtained background light estimation value.

Through the above embodiments, it can be seen that the present invention calculates dynamic compensation factors by evaluating the color attenuation degree of underwater optical images through the color correction algorithm. Considering the histogram distribution characteristics of image pixels, the pixel distribution standard deviations between different color channels are utilized as constraints for color restoration. Using a block-indexing strategy, the background light region is gradually located through recursive iteration. The present invention solves the problem of inaccurate image color correction; solves the problem of incomplete color restoration for images with different degrees of color attenuation; and improves the accuracy of background light estimation in combination with block-indexing.

Embodiment 2, the present invention provides an underwater optical image enhancement system, the system comprises:
An underwater image color correction module, configured to perform color correction on the underwater image based on the dynamic compensation factors, to calculate the dynamic compensation factors by evaluating the color attenuation degree of the underwater optical image, and to correct the color of the underwater image by utilizing the pixel distribution standard deviations between the different color channels based on the histogram distribution characteristics of the image pixels;
A background light estimation value determination module, configured to finally determine the background light estimation value based on the corrected image color after underwater image color correction by utilizing the block-indexing strategy through recursive iteration and gradual localization until the set threshold is met; and An underwater image enhancement module, configured to complete the enhancement of the underwater image based on the obtained background light estimation value.

To further illustrate the relevant effects of the embodiments of the present invention, the following experiments are conducted.

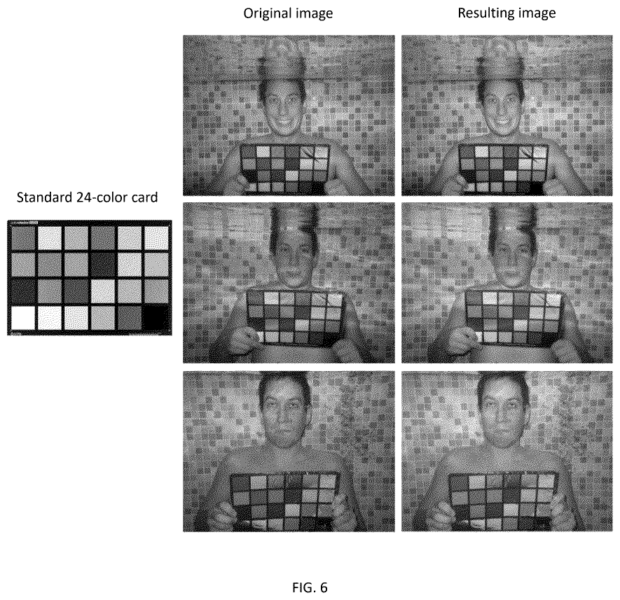

Color correction effect verification, wherein the present invention selects underwater optical images containing a standard 24-color card as verification for color restoration degree. From FIG. 6, the color restoration verification effect diagram of the method proposed by the present invention, the left side of FIG. 6 is the standard 24-color card, the middle of FIG. 6 is the original image, and the right side of FIG. 6 is the result image

It can be seen from FIG. 6 that, compared with the standard 24-color card, the results indicate that the method of the present invention can achieve satisfactory effects, and the colors on the color card are accurately restored. Each image in the image dataset used in FIG. 6 is captured by different cameras, which indicates that the color correction method proposed by the present invention is not affected by camera parameters.

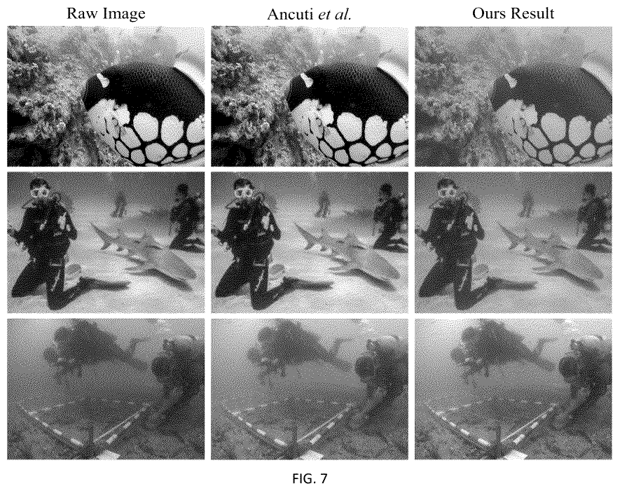

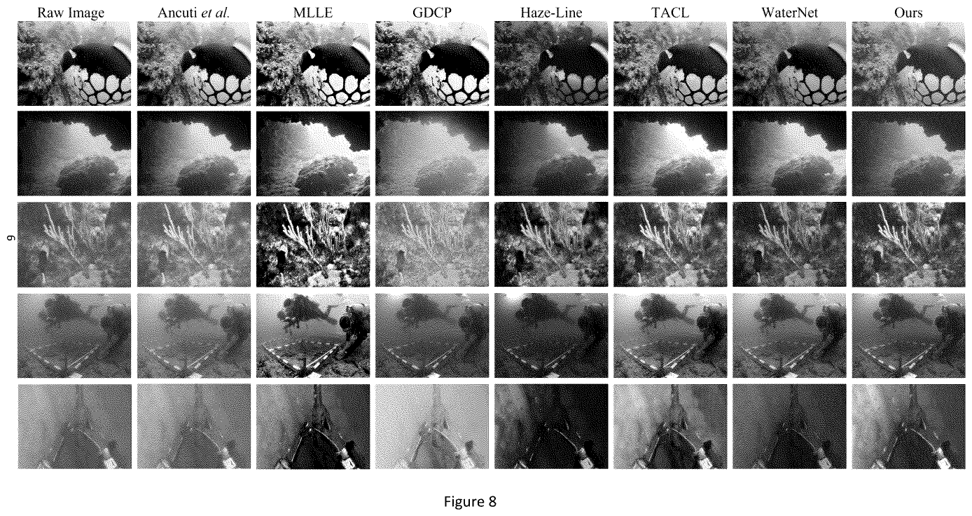

Dynamic compensation for different degradation degrees, As shown in FIG. 7, the effect diagram of color correction results for images with different degradation degrees, the present invention selects three underwater images with different degradation degrees and conducts a comparative experiment with classical methods. The experimental results show that for images with more severe color attenuation, the method of the present invention significantly outperforms classical methods in terms of color correction effect.

The present invention validates the effectiveness of the proposed underwater image enhancement method by performing the complete process of color correction and image defogging to obtain clear underwater optical images, and compares it with representative methods. The images used in the experiments of the present invention are all based on publicly available real underwater optical image datasets on the internet (such as UIEB, EUVP, OceanDark, etc.).

FIG. 8 is a comparison schematic diagram between the present invention and mainstream methods, with the last column being the result image of the present invention. Experiments indicate that, in terms of image defogging, the background light estimation optimization based on the block-indexing strategy is performed on the color-corrected image. During the iteration process, the characteristic that pixel intensities in the background light region are relatively high ensures that sub-images containing the background light have larger pixel average values. Simultaneously, the continuity of background light distribution ensures that the standard deviation of sub-images containing the background light is relatively small.

The foregoing are only preferred specific embodiments of the present invention, but the protection scope of the present invention is not limited thereto. Any modifications, equivalent substitutions, and improvements made by those skilled in the art within the technical scope disclosed in the present invention, and within the spirit and principles of the present invention, should be covered within the protection scope of the present invention.

1. An underwater optical image enhancement method, comprising the following steps:
S1, performing color correction on an underwater image based on dynamic compensation factors, calculating dynamic compensation factors by evaluating color attenuation degree of the underwater optical image; correcting a color of the underwater image by utilizing pixel distribution standard deviations between different color channels based on histogram distribution characteristics of image pixels;
S2, based on the corrected image color after underwater image color correction, determining a background light estimation value by utilizing a block-indexing strategy through recursive iteration and gradual localization until a set threshold is met; and
S3, completing enhancement of the underwater image based on the obtained background light estimation value.

2. The underwater optical image enhancement method according to claim 1, wherein in step S1, calculating the dynamic compensation factors comprises: according to gray world assumption, for a color-normal image, average values of each of the color channels tend to be the same, and for color attenuation of the underwater image, the color attenuation degree is divided into three levels, comprising mild, moderate, and severe; defining the dynamic compensation factors, performing targeted color compensation on the image according to the different color attenuation degrees, in the targeted color compensation, the Color Cast Value is obtained as follows:
Color Cast Value=max(Ī_{c})−min(Ī_{c})
wherein, I_{c} represents the image before color compensation, and Ī_{c} represents a mean value of I_{c}.

3. The underwater optical image enhancement method according to claim 2, wherein a color compensation process for a pixel position x in the image comprises:
normalizing a pixel value of each of the channels to the interval [0, 1]; the color compensation process for the pixel position x in the image is expressed as follows:
$${I}_{c}^{e} = {I}_{c} ( x ) + ( {\overline{I}}_{ref} - \overline{{I}_{c}} ) ( 1 - {I}_{c} ( x ) ) {I}_{ref} ( x )$$
regarding the histogram distribution characteristics between the color channels, a ratio of the standard deviations is configured to optimize the color compensation process for the pixel position x in the image, a color correction method is expressed as follows:
$$\{ \begin{matrix}{I}_{c}^{e} ( x ) = {I}_{c} ( x ) + ( {\overline{I}}_{ref} - \overline{{I}_{c}} ) ( 1 - {I}_{c} ( x ) ) {I}_{ref} ( x ) \\ {I}_{c}^{f} ( x ) = β \times \frac{σ ( {I}_{ref} )}{σ ( {I}_{c}^{e} )} \times {I}_{c}^{e} ( x )\end{matrix}$$
wherein,
$${I}_{c}^{e}$$
represents the preliminarily color-compensated image, I_{ref} represents one of the color channels with a largest pixel mean value,
$${I}_{c}^{f} ( x )$$
represents a final enhancement result at the position x in the image, σ( ) denotes solving the standard deviation, β represents the dynamic compensation factor whose value is adjusted according to the different color attenuation degrees; x represents the pixel position of the in the image; Ī_{ref} represents a mean value of I_{ref}, c∈{r, g, b}, wherein r represents the red channel, g represents the green channel, and b represents the blue channel;

4. The underwater optical image enhancement method according to claim 1, wherein in step S2, determining the background light estimation value comprises:
S201, inputting the color-corrected underwater image;
S202, obtaining the dark channel image;
S203, executing the block-indexing strategy, wherein dividing the dark channel image into four equally sized sub-images; performing score statistics on the blocked sub-images;
S204, iteratively selecting the sub-images with the highest scores as background light candidate regions by continuously iterating on sub-regions with the highest scores until a size of the sub-region meets a preset threshold; if the preset threshold is met, proceeding to step S205; and
S205, mapping the present region to the color-corrected underwater input image and selecting the maximum pixel value of the input image as the background light estimation value.

5. The underwater optical image enhancement method according to claim 4, wherein in step S203, the score calculation formula is as follows:
Score=mean(I_{sub})−std(I_{sub})
wherein, Score represents the score of the present region, I_{sub} represents the segmented sub-region, mean( ) denotes solving the mean value, and std( ) denotes solving the standard deviation.

6. The underwater optical image enhancement method according to claim 4, wherein in step S204, if the preset threshold is not met, the process returns to step S203.

7. The underwater optical image enhancement method according to claim 4, wherein in step S205, the maximum pixel value of the input image is the point with the highest brightness.

8. An underwater optical image enhancement system, wherein the system implements the underwater optical image enhancement method according to any one of claims 1 to 7, wherein the system comprises:
an underwater image color correction module, configured to perform color correction on the underwater image based on the dynamic compensation factors, to calculate the dynamic compensation factors by evaluating the color attenuation degree of the underwater optical image, and to correct the color of the underwater image by utilizing the pixel distribution standard deviations between the different color channels based on the histogram distribution characteristics of the image pixels;
a background light estimation value determination module, configured to finally determine the background light estimation value based on the corrected image color after underwater image color correction by utilizing the block-indexing strategy through recursive iteration and gradual localization until the set threshold is met; and
an underwater image enhancement module, configured to complete the enhancement of the underwater image based on the obtained background light estimation value.

9. The underwater optical image enhancement system according to claim 8, wherein the underwater optical image enhancement system is stored on computer-readable storage medium, the computer-readable storage medium stores a computer program that, when executed by a processor, is operable to implement functions of the aforementioned underwater optical image enhancement system.

10. The underwater optical image enhancement system according to claim 8, wherein the underwater optical image enhancement system is applied in underwater optical imaging systems for marine ecological monitoring and underwater engineering inspection.
